(19) United States
(12) Patent Application Publication
(10) Pub. No.: US 2024/0089083 A1
(43) Pub. Date: Mar. 14, 2024

(54) SECURE MULTIPARTY COMPUTE USING HOMOMORPHIC ENCRYPTION

(71) Applicant: Intel Corporation, Santa Clara, CA (US)

(72) Inventors: Kylan Race, Austin, TX (US); Ernesto Zamora Ramos, Folsom, CA (US); Jeremy Bottleson, North Plains, OR (US); Jingyi Jin, San Jose, CA (US)

(73) Assignee: Intel Corporation, Santa Clara, CA (US)

(21) Appl. No.: 17/931,438

(22) Filed: Sep. 12, 2022

(51) Int. Cl. H04L 9/00; H04L 9/06

(52) U.S. Cl. CPC H04L 9/008; H04L 9/0656; H04L 2209/46

(57) ABSTRACT

A method comprises receiving, from a remote device, a first encrypted data set encrypted using a first encryption scheme, performing a set of computations on the first encrypted data set to generate a first set of encrypted results, encrypting the first set of encrypted results using a second encryption scheme to generate a second set of encrypted results, sending the second set of encrypted results to the remote device, receiving, from the remote device, third set of encrypted results in which the first encryption scheme has been decrypted, and generating a set of decrypted results by applying a decryption algorithm to the third set of encrypted results to decrypt the second encryption scheme.

### BACKGROUND

Subject matter described herein relates generally to the field of computer security and more particularly to technologies to implement secure multiparty compute using homomorphic encryption.

Multiparty compute (or computing) refers to the use of multiple compute resources which may be owned or managed by different entities to operate on data which may be owned by a separate party. Multiparty compute presents significant large privacy and security concern that will only grow overtime with increased adoption. Accordingly, techniques to implement secure multiparty compute may find utility.

### BRIEF DESCRIPTION OF THE DRAWINGS

The detailed description is described with reference to the accompanying figures.

FIG. 1 is a schematic, block diagram illustration of components of an environment to implement secure multiparty compute using homomorphic encryption in accordance with some examples.

FIG. 2 is a flowchart illustrating operations in a method to implement secure multiparty compute using homomorphic encryption in accordance with some examples.

FIG. 3 is a schematic, block diagram illustration of components of apparatus to implement secure multiparty compute using homomorphic encryption in accordance with some examples.

FIG. 4 is a flowchart illustrating operations in a method to implement secure multiparty compute using homomorphic encryption in accordance with some examples.

FIG. 5 is a schematic illustration of a computing architecture which may be adapted to implement secure multiparty compute using homomorphic encryption in accordance with some examples.

### DETAILED DESCRIPTION

Described herein are exemplary systems and methods to implement secure multiparty compute using homomorphic encryption. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the examples.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

As described briefly above, multiparty compute (or computing) refers to the use of multiple compute resources which may be owned or managed by different entities to operate on data which may be owned by a separate party. Multiparty compute presents significant large privacy and security concern that will only grow overtime with increased adoption.

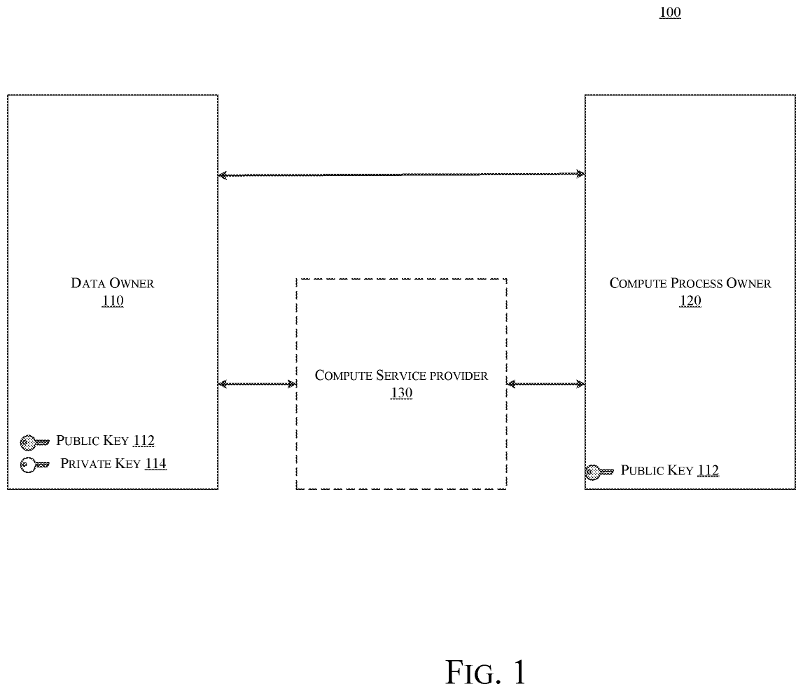

To address these and other issues, described herein are systems and methods to implement multiparty compute using homomorphic encryption. In accordance with some examples, subject matter described herein provides techniques that enables the owner(s) of a data set to allow one or more second parties to perform operations on the data set without compromising the contents of the data set. Similarly, the one or more second parties may share the results of the results of the computations on the data set with themselves or other second parties without revealing the contents of the results or the compute operations performed by the one or more second parties. In some examples, the original data set is encrypted by the owner(s) of the data set using homomorphic encryption (HE). Homomorphic encryption allows computations to be performed on data that is encrypted without revealing input and output information to the entity performing the computations (e.g., compute service providers). After the computations are performed on the encrypted data set, the resulting data set is encrypted using a second encryption technique, e.g., a one-time pad. The double-encrypted data is then returned to the owner(s), which decrypt the homomorphic encryption from the double-encrypted data set. The resulting data set is returned to the one or more second parties, which decrypt the send encryption technique (e.g., the one-time pad) applied to the data to generate a cleartext data set of results. Additional techniques are described to enable third-party compute providers. Further structural and methodological details are relating to implementing a privacy preserving digital personal assistant are described below with reference to FIG. 1 through FIG. 5, below

FIG. 1 is a schematic, block diagram illustration of components of an environment to implement secure multiparty compute using homomorphic encryption in accordance with some examples. Referring to FIG. 1, in some examples, environment 100 comprises a data owner 100, a compute process owner 120, and an optional trusted compute service 130.

Data owner 100 may represent the owner(s) of a data set. For example, data owner 100 may own one or more data sets comprising financial data, health data, or other types of data that data owner 100 may want, or be required by law, to keep secure. Data owner 110 may further comprise a public encryption key 112 and a private encryption key 114 for use in encryption techniques.

Compute process owner 120 may own one or more proprietary techniques for data analysis which may be applicable to the one or more data sets owned by data owner 110. Compute process owner 120 may want, or be required by law, to keep the proprietary techniques and the results of applying the proprietary techniques to the one or more data sets secure. In some examples compute process owner 120 may possess sufficient compute resources to implement its compute process. In other examples, compute process owner may utilize the services of a third-party compute service provider 130 for all or part of the computations performed by compute process owner 120. In this case, both the data and the computational techniques performed by compute process owner need to be secured, such that computer service provider 130 cannot access the data or the computational techniques.

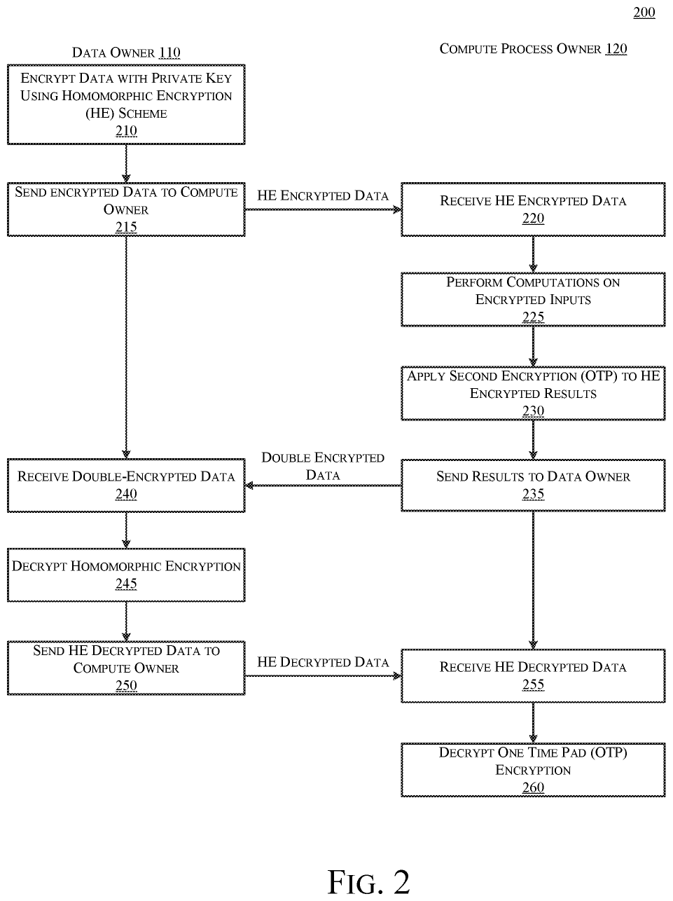

FIG. 2 is a flowchart illustrating operations in a method 200 to implement secure multiparty compute using homomorphic encryption in accordance with some examples. Referring to FIG. 2, a data owner 100 has a data set sensitive data that the data owner 110 does not want the compute process owner 120 to access. At operation 210 the data owner encrypts the data set with a private encryption key 114 using a homomorphic encryption scheme to generate a first encrypted data set. At operation 215 the first encrypted data set is sent to the compute process owner 120 by a suitable communication connection. The communication connection may be encrypted or may be unencrypted.

At operation 220 the compute process owner 120 receives the homomorphic encrypted data set from the data owner 110. Compute process owner 120 does not possess a private key and therefore cannot decrypt the homomorphically encrypted data. At operation 225 the computer process owner 120 implements one or more computations on the data set to generate a first set of encrypted results.

At operation 230 the compute process owner 120 applies a second encryption technique to the first set of encrypted results to generate a second set of encrypted results. In some examples, the secondary encryption is specifically applied homomorphically in the homomorphic encryption space to the contents of the ciphertex. In some examples the second encryption technique may be a one-time pad (OTP), which requires a single-use key that is not smaller than the message being sent. In this technique, a data element is paired with the random single-use secret key (also referred to as a one-time pad). Then, each element of the data is encrypted by combining it with the corresponding element from the pad using addition. Thus, the second set of encrypted results are double encrypted, once with the homomorphic encryption scheme applied by data owner 110, and once with the one-time pad applied by the compute process owner. At operation 235 the compute process owner 120 sends the double-encrypted second data set back to the data owner 110 via a suitable communication link.

At operation 240 the data owner 110 receives the double-encrypted second data set which comprises the results of the computations performed on the data by compute process owner 120. At operation 245 the data owner decrypts the homomorphic encryption applied to the data using the private key 114 used to encrypt the original data set, resulting in a set of partially decrypted results. The partially decrypted results are homomorphically decrypted but remain encrypted by the one-time pad operation applied by the compute process owner 120. Because the set of partially encrypted results is still encrypted by the one-time pad applied by the compute process owner 120, the data owner 110 cannot access the results. At operation 250 the set of partially decrypted results are sent to the compute process owner 120 via a suitable communication link. The communication link may be encrypted or may be unencrypted.

At operation 255 the compute process owner 120 receives the set of partially decrypted results from the data owner 110. At operation 260, the compute process owner decrypts the second encryption process (e.g., the one-time pad) applied to the data set in operation 230, thereby generating a set of decrypted results which are in cleartext. Thus, the operations depicted in FIG. 2 enable the compute process owner 120 to perform computations on the data set owned by the data owner 110 without compromising the security of the underlying data and without revealing to the data owner 110 the computational techniques applied by the compute process owner 120 or the results of the applying the computational techniques to the data set.

In some examples, compute process owner 120 may utilize the services of a third-party compute service provider, e.g., a cloud-based compute platform. In this case both the data set(s) owned by the data owner 110 and the techniques owned by the compute process owner 120 need to be secured such that they are protected from the compute service provider 130.

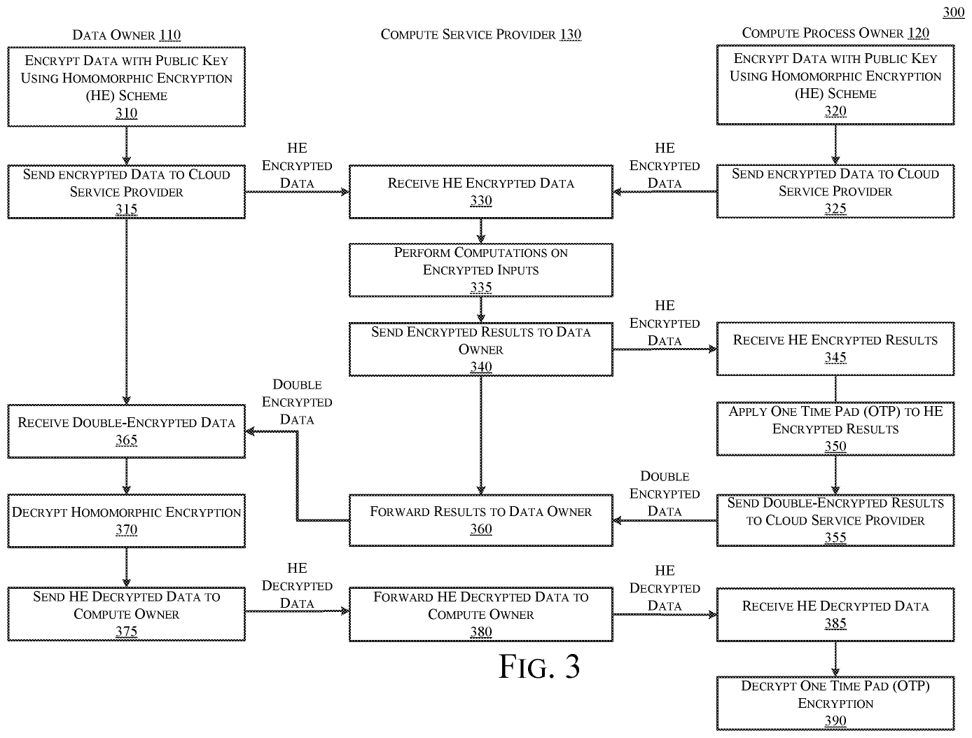

FIG. 3 is a flowchart illustrating operations in a method 300 to implement secure multiparty compute using homomorphic encryption in accordance with some examples. Referring to FIG. 3, at operation 310 the data owner encrypts the data set with a public encryption key 114 using a homomorphic encryption scheme to generate a first encrypted data set. At operation 315 the first encrypted data set is sent to the compute service provider 120 by a suitable communication link. The communication link may be encrypted or may be unencrypted.

At operation 320 the compute process owner 120 encrypts its data using the public encryption key 114 possessed by the data owner 110 to apply a homomorphic encryption scheme to generate an encrypted data set. At operation 315 the encrypted data set is sent to the compute service provider 120 by a suitable communication connection. The communication connection may be encrypted or may be unencrypted.

At operation 330 the compute service provider 130 receives the homomorphically encrypted data sets from the data owner 110 and the compute service provider 120. At operation 335 the compute service provider 130 performs the computations represented by the data set provided by the compute process owner 120 to the data set provided by the data owner 110 to generate first set of encrypted results. At operation 340 the first set of encrypted results is sent to the compute process owner 130 via a suitable communication link. The communication link may be encrypted or may be unencrypted.

At operation 345 the compute process owner 120 receives the first set of homomorphically encrypted results. At operation 350 the compute process owner 120 applies a second encryption technique to the first set of encrypted results to generate a second set of encrypted results. In some examples the second encryption technique may be a one-time pad (OTP), which requires a single-use key that is not smaller than the message being sent. In this technique, a data element is paired with the random single-use secret key (also referred to as a one-time pad). Then, each element of the data is encrypted by combining it with the corresponding element from the pad using addition. Thus, the second set of encrypted results are double encrypted, once with the homomorphic encryption scheme applied by data owner 110, and once with the one-time pad applied by the compute process owner 120. At operation 355 the compute process owner 120 sends the double-encrypted second data set to the compute service provider 130, which forwards the double-encrypted second data set to the data owner 110 via a suitable communication link. The communication link may be encrypted or may be unencrypted.

At operation 365 the data owner 110 receives the double-encrypted second data set which comprises the results of the computations performed on the data by compute service provider 130. At operation 370 the data owner 110 decrypts the homomorphic encryption applied to the data using the private key 114, resulting in a set of partially decrypted results. The partially decrypted results are homomorphically decrypted but remain encrypted by the one-time pad operation applied by the compute process owner 120. Because the set of partially encrypted results is still encrypted by the one-time pad applied by the compute process owner 120, the data owner 110 cannot access the results. At operation 375 the set of partially decrypted results are sent to the compute process owner 120 via a suitable communication link. At operation 380 the compute service provider 130 forwards the homomorphically decrypted data to the compute process owner via a suitable communication link. The communication link may be encrypted or may be unencrypted.

At operation 385 the compute process owner 120 receives the set of partially decrypted results from the compute service provider. At operation 390, the compute process owner decrypts the second encryption process (e.g., the one-time pad) applied to the data set in operation 350, thereby generating a set of decrypted results which are in cleartext. Thus, the operations depicted in FIG. 3 enable the compute service provider 130 to perform computations on the data set owned by the data owner 110 using the techniques owned by the compute process owner 120 without compromising the security of the underlying data and without revealing to the data owner 110 the computational techniques applied by the compute process owner 120 or the results of the applying the computational techniques to the data set.

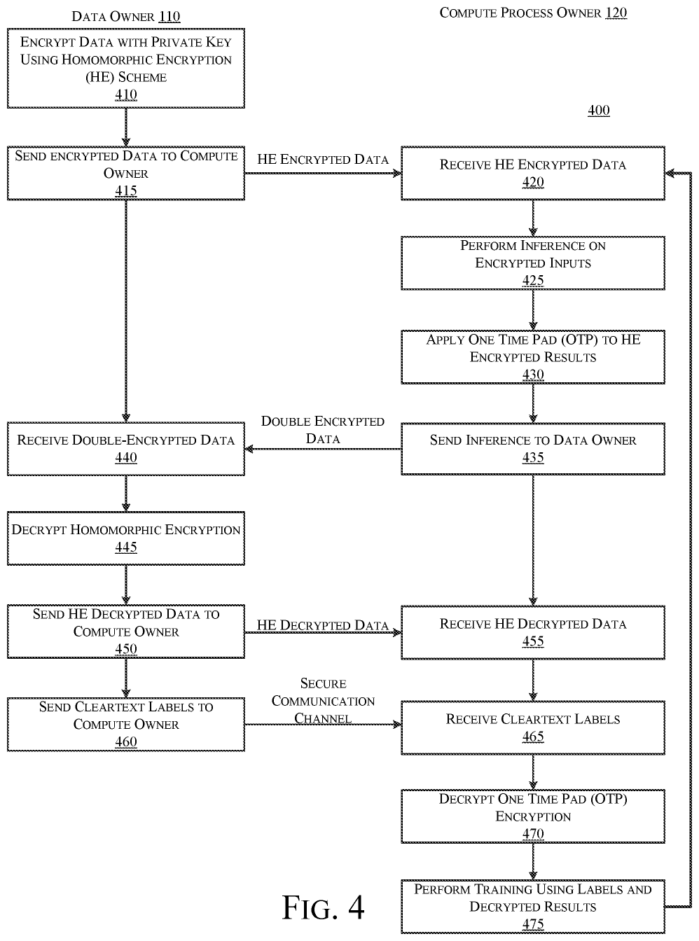

In some examples techniques described herein may be applied to machine learning algorithms. FIG. 4 is a flowchart illustrating operations in a method 400 to implement secure multiparty compute using homomorphic encryption in accordance with some examples. Referring to FIG. 4, at operation 410 the data owner 110 encrypts the data set with a private encryption key 114 using a homomorphic encryption scheme to generate a first encrypted data set. At operation 415 the first encrypted data set is sent to the compute process owner 120 by a suitable communication connection. The communication connection may be encrypted or may be unencrypted.

At operation 420 the compute process owner 120 receives the homomorphic encrypted data set from the data owner 110. Compute process owner 120 does not possess a private key and therefore cannot decrypt the homomorphically encrypted data. At operation 425 the computer process owner 120 implements one or more computations on the data set to generate a first set of encrypted results.

At operation 430 the compute process owner 120 applies a second encryption technique to the first set of encrypted results to generate a second set of encrypted results. In some examples the second encryption technique may be a one-time pad (OTP), which requires a single-use key that is not smaller than the message being sent. In this technique, a data element is paired with the random single-use secret key (also referred to as a one-time pad). Then, each element of the data is encrypted by combining it with the corresponding element from the pad using addition. Thus, the second set of encrypted results are double encrypted, once with the homomorphic encryption scheme applied by data owner 110, and once with the one-time pad applied by the compute process owner. At operation 435 the compute process owner 120 sends the double-encrypted second data set back to the data owner 110 via a suitable communication link.

At operation 440 the data owner 110 receives the double-encrypted second data set which comprises the results of the computations performed on the data by compute process owner 120. At operation 445 the data owner decrypts the homomorphic encryption applied to the data using the private key 114 used to encrypt the original data set, resulting in a set of partially decrypted results. The partially decrypted results are homomorphically decrypted but remain encrypted by the one-time pad operation applied by the compute process owner 120. Because the set of partially encrypted results is still encrypted by the one-time pad applied by the compute process owner 120, the data owner 110 cannot access the results. At operation 450 the set of partially decrypted results are sent to the compute process owner 120 via a suitable communication link. The communication link may be encrypted or may be unencrypted.

At operation 460 the data owner sends the cleartext labels associated with the data to the compute process owner 130. At operation 465 the compute process owner receives the cleartext labels.

At operation 470, the compute process owner decrypts the second encryption process (e.g., the one-time pad) applied to the data set in operation 430, thereby generating a set of decrypted results which are in cleartext. At operation 475 the compute process owner 120 performs one or more iterations of machine language using the labels and the decrypted results. The training step occurs in the cleartext domain rather than in the encrypted domain, which reduces the amount of time and computation required to develop a fully accurate machine learning model. Thus, the operations depicted in FIG. 4 enable the compute process owner 120 to perform computations on the data set owned by the data owner 110 without compromising the security of the underlying data and without revealing to the data owner 110 the computational techniques applied by the compute process owner 120 or the results of the applying the computational techniques to the data set.

An example of a use case involves an data owner that generates data, such as using camera captures, and a compute process owner which wants to gain access to the data owner's camera feed data to compute some statistics, e.g., predict weather, count items, etc. However, some or all of data may be sensitive and should not be viewed by anyone outside of the data owner's organization. Further, the compute process owner doesn't want to expose their computation model. In this case, both entities can use their solution to achieve their goals. The data owner can serve the private data for computations without exposing the data itself, while the compute process owner can use the data in their computations without exposing their models.

Another potential use case is made apparent with financial entities that are required to adhere to know your client (KYC) compliance procedures. In general, KYC processes cost the average bank millions of dollars per year. This, when also accounting for the time required to carry out the process, means it's one of the biggest resource sinks for these types of firms. Large firms utilize pre-trained models to carry out the risk assessment portion of this pipeline, but only after spending the time and resources to build a user profile that can be used to make inferences. By contrast, small firms may not have access to pre-trained models, and as such may need to train their own. This can be extremely costly both to gather the data and to obtain the compute resources to carry out the training. Using techniques described herein, the risk assessment portion of that pipeline can be streamlined. As described here, a large firm would not need to spend the resources gathering and paying for the data in question, as the data-owning firms could let them use the encrypted representation of it for inferencing without revealing the content of the data. The compute process owner would be able to run their risk assessment without revealing their method of doing so, and without the data-owner revealing their assets.

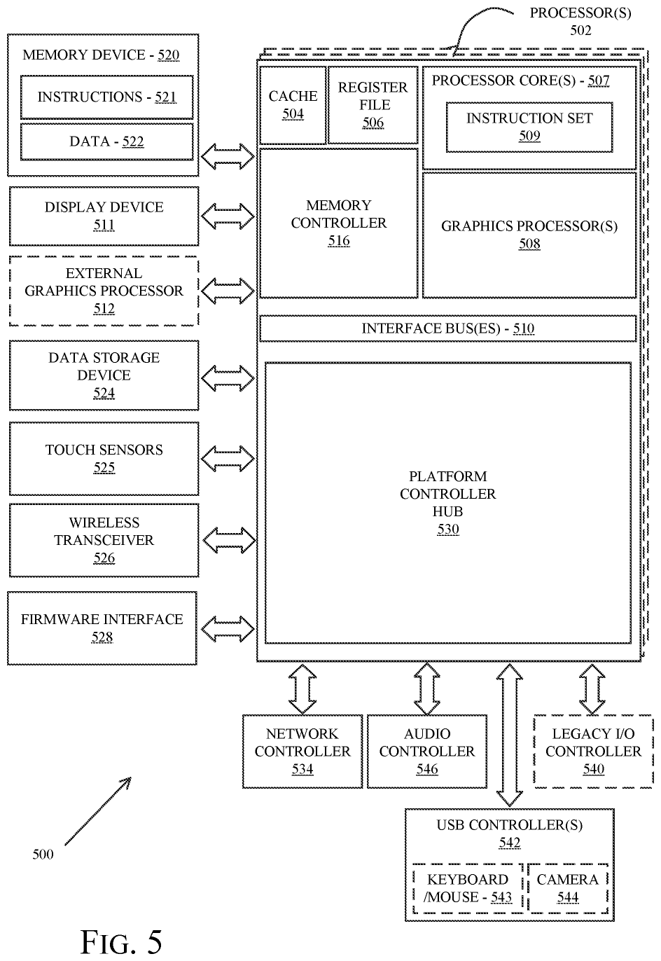

FIG. 5 illustrates an embodiment of an exemplary computing architecture that may be suitable for implementing various embodiments as previously described. In various embodiments, the computing architecture 500 may comprise or be implemented as part of an electronic device. In some embodiments, the computing architecture 500 may be representative, for example of a computer system that implements one or more components of the operating environments described above. In some embodiments, computing architecture 500 may be representative of one or more portions or components of a digital signature signing system that implement one or more techniques described herein. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 500.

As shown in FIG. 5, the computing architecture 500 includes one or more processors 502 and one or more graphics processors 508, and may be a single processor desktop system, a multiprocessor workstation system, or a server system having a large number of processors 502 or processor cores 507. In on embodiment, the system 500 is a processing platform incorporated within a system-on-a-chip (SoC or SOC) integrated circuit for use in mobile, handheld, or embedded devices.

An embodiment of system 500 can include, or be incorporated within, a server-based gaming platform, a game console, including a game and media console, a mobile gaming console, a handheld game console, or an online game console. In some embodiments system 500 is a mobile phone, smart phone, tablet computing device or mobile Internet device. Data processing system 500 can also include, couple with, or be integrated within a wearable device, such as a smart watch wearable device, smart eyewear device, augmented reality device, or virtual reality device. In some embodiments, data processing system 500 is a television or set top box device having one or more processors 502 and a graphical interface generated by one or more graphics processors 508.

In some embodiments, the one or more processors 502 each include one or more processor cores 507 to process instructions which, when executed, perform operations for system and user software. In some embodiments, each of the one or more processor cores 507 is configured to process a specific instruction set 509. In some embodiments, instruction set 509 may facilitate Complex Instruction Set Computing (CISC), Reduced Instruction Set Computing (RISC), or computing via a Very Long Instruction Word (VLIW). Multiple processor cores 507 may each process a different instruction set 509, which may include instructions to facilitate the emulation of other instruction sets. Processor core 507 may also include other processing devices, such a Digital Signal Processor (DSP).

In some embodiments, the processor 502 includes cache memory 504. Depending on the architecture, the processor 502 can have a single internal cache or multiple levels of internal cache. In some embodiments, the cache memory is shared among various components of the processor 502. In some embodiments, the processor 502 also uses an external cache (e.g., a Level-3 (L3) cache or Last Level Cache (LLC)) (not shown), which may be shared among processor cores 507 using known cache coherency techniques. A register file 506 is additionally included in processor 502 which may include different types of registers for storing different types of data (e.g., integer registers, floating point registers, status registers, and an instruction pointer register). Some registers may be general-purpose registers, while other registers may be specific to the design of the processor 502.

In some embodiments, one or more processor(s) 502 are coupled with one or more interface bus(es) 510 to transmit communication signals such as address, data, or control signals between processor 502 and other components in the system. The interface bus 510, in one embodiment, can be a processor bus, such as a version of the Direct Media Interface (DMI) bus. However, processor busses are not limited to the DMI bus, and may include one or more Peripheral Component Interconnect buses (e.g., PCI, PCI Express), memory busses, or other types of interface busses. In one embodiment the processor(s) 502 include an integrated memory controller 516 and a platform controller hub 530. The memory controller 516 facilitates communication between a memory device and other components of the system 500, while the platform controller hub (PCH) 530 provides connections to I/O devices via a local I/O bus.

Memory device 520 can be a dynamic random-access memory (DRAM) device, a static random-access memory (SRAM) device, flash memory device, phase-change memory device, or some other memory device having suitable performance to serve as process memory. In one embodiment the memory device 520 can operate as system memory for the system 500, to store data 522 and instructions 521 for use when the one or more processors 502 executes an application or process. Memory controller hub 516 also couples with an optional external graphics processor 512, which may communicate with the one or more graphics processors 508 in processors 502 to perform graphics and media operations. In some embodiments a display device 511 can connect to the processor(s) 502. The display device 511 can be one or more of an internal display device, as in a mobile electronic device or a laptop device or an external display device attached via a display interface (e.g., DisplayPort, etc.). In one embodiment the display device 511 can be a head mounted display (HMD) such as a stereoscopic display device for use in virtual reality (VR) applications or augmented reality (AR) applications.

In some embodiments the platform controller hub 530 enables peripherals to connect to memory device 520 and processor 502 via a high-speed I/O bus. The I/O peripherals include, but are not limited to, an audio controller 546, a network controller 534, a firmware interface 528, a wireless transceiver 526, touch sensors 525, a data storage device 524 (e.g., hard disk drive, flash memory, etc.). The data storage device 524 can connect via a storage interface (e.g., SATA) or via a peripheral bus, such as a Peripheral Component Interconnect bus (e.g., PCI, PCI Express). The touch sensors 525 can include touch screen sensors, pressure sensors, or fingerprint sensors. The wireless transceiver 526 can be a Wi-Fi transceiver, a Bluetooth transceiver, or a mobile network transceiver such as a 3G, 4G, or Long Term Evolution (LTE) transceiver. The firmware interface 528 enables communication with system firmware, and can be, for example, a unified extensible firmware interface (UEFI). The network controller 534 can enable a network connection to a wired network. In some embodiments, a high-performance network controller (not shown) couples with the interface bus 510. The audio controller 546, in one embodiment, is a multi-channel high definition audio controller. In one embodiment the system 500 includes an optional legacy I/O controller 540 for coupling legacy (e.g., Personal System 2 (PS/2)) devices to the system. The platform controller hub 530 can also connect to one or more Universal Serial Bus (USB) controllers 542 connect input devices, such as keyboard and mouse 543 combinations, a camera 544, or other USB input devices.

The following pertains to further examples.

Example 1 is an apparatus, comprising processing circuitry to receive, from a remote device, a first encrypted data set encrypted using a first encryption scheme; perform a set of computations on the first encrypted data set to generate a first set of encrypted results; encrypt the first set of encrypted results using a second encryption scheme to generate a second set of encrypted results; send the second set of encrypted results to the remote device; receive, from the remote device, third set of encrypted results in which the first encryption scheme has been decrypted; and generate a set of decrypted results by applying a decryption algorithm to the third set of encrypted results to decrypt the second encryption scheme.

In Example 2, the subject matter of Example 1 can optionally include an arrangement wherein the first encryption scheme comprises a homomorphic encryption scheme.

In Example 3, the subject matter of any one of Examples 1-2 can optionally include an arrangement wherein the second encryption scheme comprises a one-time pad.

Example 4 is a computer-based method, comprising receiving, from a remote device, a first encrypted data set encrypted using a first encryption scheme; performing a set of computations on the first encrypted data set to generate a first set of encrypted results; encrypting the first set of encrypted results using a second encryption scheme to generate a second set of encrypted results; sending the second set of encrypted results to the remote device; receiving, from the remote device, third set of encrypted results in which the first encryption scheme has been decrypted; and generating a set of decrypted results by applying a decryption algorithm to the third set of encrypted results to decrypt the second encryption scheme.

In Example 5, the subject matter of Example 6 further comprising an arrangement wherein the first encryption scheme comprises a homomorphic encryption scheme.

In Example 6, the subject matter of any one of Examples 5-6 can optionally include an arrangement wherein the second encryption scheme comprises a one-time pad.

Example 7 is a non-transitory computer readable medium comprising instructions which, when executed by a processor, configure the processor toto receive, from a remote device, a first encrypted data set encrypted using a first encryption scheme; perform a set of computations on the first encrypted data set to generate a first set of encrypted results; encrypt the first set of encrypted results using a second encryption scheme to generate a second set of encrypted results; send the second set of encrypted results to the remote device; receive, from the remote device, third set of encrypted results in which the first encryption scheme has been decrypted; and generate a set of decrypted results by applying a decryption algorithm to the third set of encrypted results to decrypt the second encryption scheme

In Example 8, the subject matter Example 7 can optionally include an arrangement wherein the first encryption scheme comprises a homomorphic encryption scheme.

In Example 9, the subject matter of any one of Examples 7-8 can optionally include an arrangement wherein the second encryption scheme comprises a one-time pad.

Example 10 is an apparatus, comprising processing circuitry to generate a first encrypted data set encrypted using a first encryption scheme; send the first encrypted data set to a remote device; receive, from the remote device, a set of double encrypted results encrypted using the first encryption scheme and a second encryption scheme; and generate a set of partially decrypted results by applying a decryption algorithm to the set of double encrypted results to decrypt the second encryption scheme; and send the set of partially decrypted results to the remote device.

In Example 11, the subject matter of Example 10 can optionally include an arrangement wherein the first encryption scheme comprises a homomorphic encryption scheme.

In Example 12, the subject matter of any one of Examples 10-11 can optionally include an arrangement wherein the second encryption scheme comprises a one-time pad.

Example 13 is a computer-based method, comprising generating a first encrypted data set encrypted using a first encryption scheme; sending the first encrypted data set to a remote device; receiving, from the remote device, a set of double encrypted results encrypted using the first encryption scheme and a second encryption scheme; generating a set of partially decrypted results by applying a decryption algorithm to the set of double encrypted results to decrypt the second encryption scheme; and send the set of partially decrypted results to the remote device

In Example 14, the subject matter of Example 13 can optionally include an arrangement wherein the first encryption scheme comprises a homomorphic encryption scheme,

In Example 15, the subject matter of any one of Examples 13-14 can optionally include the subject matter of claim 15, comprising an arrangement wherein the second encryption scheme comprises a one-time pad.

Example 16 is a non-transitory computer readable medium comprising instructions which, when executed by a processor, configure the processor to generate a first encrypted data set encrypted using a first encryption scheme; send the first encrypted data set to a remote device; receive, from the remote device, a set of double encrypted results encrypted using the first encryption scheme and a second encryption scheme; generate a set of partially decrypted results by applying a decryption algorithm to the set of double encrypted results to decrypt the second encryption scheme; and send the set of partially decrypted results to the remote device.

In Example 17, the subject matter of Example 16 can optionally include the subject matter of claim 15, comprising an arrangement wherein the first encryption scheme comprises a homomorphic encryption scheme.

In Example 18, the subject matter of any one of Examples 16-17 can optionally include an arrangement wherein the second encryption scheme comprises a one-time pad.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
processing circuitry to:
receive, from a remote device, a first encrypted data set encrypted using a first encryption scheme;
perform a set of computations on the first encrypted data set to generate a first set of encrypted results;
encrypt the first set of encrypted results using a second encryption scheme to generate a second set of encrypted results;
send the second set of encrypted results to the remote device;
receive, from the remote device, third set of encrypted results in which the first encryption scheme has been decrypted; and
generate a set of decrypted results by applying a decryption algorithm to the third set of encrypted results to decrypt the second encryption scheme.

2. The apparatus of claim 1, wherein the first encryption scheme comprises a homomorphic encryption scheme.

3. The apparatus of claim 1, wherein the second encryption scheme comprises a one-time pad.

4. A computer-based method, comprising:
receiving, from a remote device, a first encrypted data set encrypted using a first encryption scheme;
performing a set of computations on the first encrypted data set to generate a first set of encrypted results;
encrypting the first set of encrypted results using a second encryption scheme to generate a second set of encrypted results;
sending the second set of encrypted results to the remote device;
receiving, from the remote device, third set of encrypted results in which the first encryption scheme has been decrypted; and
generating a set of decrypted results by applying a decryption algorithm to the third set of encrypted results to decrypt the second encryption scheme.

5. The method of claim 4, wherein the first encryption scheme comprises a homomorphic encryption scheme.

6. The method of claim 4, wherein the second encryption scheme comprises a one-time pad.

7. An apparatus, comprising:
processing circuitry to:
generate a first encrypted data set encrypted using a first encryption scheme;
send the first encrypted data set to a remote device;
receive, from the remote device, a set of double encrypted results encrypted using the first encryption scheme and a second encryption scheme;
generate a set of partially decrypted results by applying a decryption algorithm to the set of double encrypted results to decrypt the second encryption scheme; and
send the set of partially decrypted results to the remote device.

8. The apparatus of claim 7, wherein the first encryption scheme comprises a homomorphic encryption scheme.

9. The apparatus of claim 7, wherein the second encryption scheme comprises a one-time pad.

10. A computer-based method, comprising:
generate a first encrypted data set encrypted using a first encryption scheme;
send the first encrypted data set to a remote device;
receive, from the remote device, a set of double encrypted results encrypted using the first encryption scheme and a second encryption scheme;
generate a set of partially decrypted results by applying a decryption algorithm to the set of double encrypted results to decrypt the second encryption scheme; and
send the set of partially decrypted results to the remote device.

11. The method of claim 10, wherein the first encryption scheme comprises a homomorphic encryption scheme.

12. The method of claim 10, wherein the second encryption scheme comprises a one-time pad.
